(19) United States
(12) Patent Application Publication
(10) Pub. No.: US 2026/0343124 A1
(43) Pub. Date: Oct. 29, 2026

(54) OPTICAL SWITCH AND DATA COMMUNICATION SYSTEM

(71) Applicant: CLOUD INTELLIGENCE ASSETS HOLDING (SINGAPORE) PRIVATE LIMITED, Singapore (SG)

(72) Inventors: Fulong YAN, Hangzhou, Zhejiang (CN); Chongjin XIE, Hangzhou, Zhejiang (CN)

(21) Appl. No.: 18/997,473

(22) PCT Filed: Jul. 20, 2023
(86) PCT No.: PCT/CN2023/108358

§ 371 Date: Jan. 21, 2025

(30) Foreign Application Priority Data
Jul. 21, 2022 (CN) 202210855906.6

(51) Int. Cl. H04Q 11/00

(52) U.S. Cl. CPC H04Q 11/0066; H04Q 11/0005; H04Q 2011/005

(57) ABSTRACT

The present application provides an optical switch and a data communication system. Each switching link of the optical switch in the present application has a cache group. For any switching link, if wavelengths of at least two optical packets that need to be output through the switching link in a time slot are identical, other optical packets except one optical packet of the optical packets can be cached in the cache group in the switching link, and the one optical packet can be output in the time slot. The other optical packets cached in the cache group can be scheduled and output in a subsequent time slot, so as to avoid conflicts. In addition, since the structure of the optical switch in the present application can support FFQ scheduling of optical packets, and FFQ scheduling can be an ideal scheduling based on GPS, broadband assurance can be achieved.

### CROSS-REFERENCE TO RELATED APPLICATIONS

This application is a National Stage of International Application No. PCT/CN2023/108358, filed on Jul. 20, 2023, which claims priority to Chinese patent application No. 202210855906.6, entitled “OPTICAL SWITCH AND DATA COMMUNICATION SYSTEM” and filed with the China National Intellectual Property Administration on Jul. 21, 2022. The afore-mentioned applications are hereby incorporated by reference in their entireties.

### TECHNICAL FIELD

The present application relates to the field of new generation information technology and, in particular, to an optical switch and a data communication system.

### BACKGROUND

Optical packet switching (OPS) is a packet switching approach often used in optical communication scenarios. Data in optical communication scenarios are often embodied as optical packets. An optical packet includes an optical packet header and an optical packet payload, etc., and an optical switch can be used for optical packet switching.

For example, the optical switch can perform optical packet switching between two data centers.

However, with the prosperous development of various applications in data centers, the demand for broadband quality of various applications in data centers is increasing. The current optical switches can provide sufficient bandwidth, but the quality of the bandwidth provided is low, which affects the quality of optical packet switching and lacks assurance of service quality.

For example, in one approach, during a process of optical packet switching by an optical switch, sometimes there may be switching conflicts occurring between some optical packets. In the case of switching conflicts occurring between some optical packets, only a part of the optical packets can be successfully switched, while the other part of the optical packets cannot be switched, which reduces the quality of optical packet switching.

### SUMMARY

In order to improve the quality of the bandwidth provided by the optical switch, for example, to improve the quality of optical packet switching by the optical switch, the present application illustrates an optical switch and a data communication system.

In a first aspect, the present application illustrates an optical switch, which includes:
P switching modules, where P includes an amount of types of wavelengths of optical packets of which switching is supported by the optical switch; each switching module includes F switching links; both P and F are positive integers;
for each of the switching links, the switching link includes: a splitter, an aggregator, F cache groups and schedulers respectively corresponding to the cache groups; each of the cache groups includes multiple cache blocks;
the splitter in the switching link is configured to: receive an input optical signal, separate the input optical signal into optical packets of various wavelengths, and for any wavelength, determine, from the P switching modules, a switching module for outputting optical packets of the wavelength, and store the optical packets of the wavelength in a cache group corresponding to the wavelength in one of the switching links of the determined switching module;
a scheduler corresponding to any one of the cache groups in the switching link is configured to schedule one of the optical packets of the wavelength in the cache group to the aggregator in the switching link;
the aggregator in the switching link is configured to aggregate optical packets of the various wavelengths respectively scheduled by the schedulers in the switching link into an output optical signal, and output the output optical signal.

In an implementation, the splitter includes:
a separator, a switch controller, label extractors respectively corresponding to the various wavelengths, and optical switching elements respectively corresponding to the various wavelengths;
the separator is configured to: receive the input optical signal, separate the input optical signal into the optical packets of the various wavelengths, and for any wavelength, input the optical packets of the wavelength into a label extractor corresponding to the wavelength;
the label extractor corresponding to the wavelength is configured to: extract optical packet headers and optical packet payloads of the optical packets of the wavelength, transmit the optical packet headers to the switch controller, and transmit the optical packet payloads to an optical switching element corresponding to the wavelength;
the switch controller is configured to: determine, from the P switching modules according to the optical packet headers, the switching module for outputting the optical packets of the wavelength, and send a cache instruction to the optical switching element corresponding to the wavelength; where the cache instruction is used to instruct to store the optical packets of the wavelength in the cache group corresponding to the wavelength in one of the switching links of the determined switching module;
the optical switching element corresponding to the wavelength is configured to store, according to the cache instruction, the optical packets of the wavelength in the cache group corresponding to the wavelength in the one of the switching links of the determined switching module.

In an implementation, the cache group corresponding to the wavelength includes multiple cache blocks, and different cache blocks respectively correspond to different switching links among the switching links included in one of the P switching modules;
the cache instruction is used to instruct to store the optical packets of the wavelength in a cache block of the cache group corresponding to the wavelength in one of the switching links of the determined switching module, where the cache block corresponds to the one of the switching links of the determined switching module;
the optical switch corresponding to the wavelength is configured to store, according to the cache instruction, the optical packets of the wavelength in the cache block of the cache group corresponding to the wavelength in the one of the switching links of the determined switching module, where the cache block corresponds to the one of the switching links of the determined switching module.

In an implementation, the cache block includes a delay feedback optical buffer.

In an implementation, the delay feedback optical buffer includes:
a first optical splitter, a first combiner, a second optical splitter, a second combiner, a controller, a first optical amplifier, a second optical amplifier, a third optical amplifier, a fourth optical amplifier and a fiber delay line circulation loop;
an input end of the first optical splitter is connected with an output end of the fiber delay line circulation loop;
an output end of the first optical splitter is connected with an input end of the first optical amplifier and an input end of the second optical amplifier;
an output end of the first optical amplifier is connected with an input end of the first combiner;
an output end of the second optical amplifier is connected with an input end of the second combiner;
an output end of the first combiner is connected with an input end of the fiber delay line circulation loop;
the second optical splitter is configured to receive the optical packets of the wavelength;
an output end of the second optical splitter is connected with an input end of the third optical amplifier and an input end of the fourth optical amplifier;
an output end of the third optical amplifier is connected with the input end of the first combiner;
an output end of the fourth optical amplifier is connected with the input end of the second combiner;
an output end of the second combiner is connected to an output end of the scheduler;
the scheduler is configured to control turning on or off of the first optical amplifier, the second optical amplifier, the third optical amplifier and the fourth optical amplifier according to the controller.

In an implementation, a storage space of the cache block is determined according to at least L_{d}, L and r;
L_{d} includes: a maximum number of bits of optical packets that can be carried simultaneously on a link between one input end of the optical switch and a device that sends the input optical signal;
L includes a number of bits of an optical packet;
r includes a rate at which the optical switch switches optical packets.

In an implementation, the storage space of the cache block is less than or equal to (4+2*L_{d}/L-r)*L.

In an implementation, an amount of the delay feedback optical buffer is determined according to L_{d} and L;
L_{d} includes: a maximum number of bits of optical packets that can be carried simultaneously on a link between one input end of the optical switch and a device that sends the input optical signal;
L includes a number of bits of an optical packet.

In an implementation, the amount of the delay feedback optical buffer is less than or equal to 4+2*L_{d}/L.

In an implementation, in a case that there are two or more delay feedback optical buffers, the two or more delay feedback optical buffers are connected in series.

In a second aspect, the present application illustrates a data communication system, and the data communication system includes:
at least one data center;
the data center includes at least one terminal, an optoelectronic conversion device communicatively connected to the at least one terminal respectively, and the optical switch according to the first aspect, where the at least one terminal is communicatively connected with an input end of the optical switch through the optoelectronic conversion device.

Compared with the prior art, the present application has the following advantages.

Each switching link of the optical switch in the present application has a cache group. For any switching link, if the wavelengths of at least two optical packets that need to be output through the switching link in a time slot are identical, other optical packets except one optical packet of the optical packets can be cached in the cache group in the switching link, and the one optical packet can be output in the time slot. The other optical packets cached in the cache group can be scheduled and output in a subsequent time slot, so as to avoid conflicts.

Secondly, the structure of the optical switch in the present application can support a flow fair queuing scheduling mechanism (FFQ, Flow Fair Queuing) scheduling of optical packets, and the scheduler close to an output end in the switching link can be used for scheduling. In this way, scheduling can be implemented based on simple scheduling logic, the complexity can be reduced to 0 (logN), and the complexity of the entire optical switch can be simplified.

In addition, since the structure of the optical switch in the present application can support FFQ scheduling of optical packets, and FFQ scheduling can be an ideal scheduling based on Generalized Processor Sharing (GPS), broadband assurance can be achieved. For example, the throughput of the optical switch for switching optical packets can be improved, so as to improve the quality of the optical switch in switching the optical packets and obtain service quality assurance.

### BRIEF DESCRIPTION OF DRAWINGS

FIG. 1 is a structural block diagram of an optical switch of the present application.

FIG. 2 is a structural block diagram of a delay feedback optical buffer of the present application.

FIG. 3 is a structural block diagram of a delay feedback optical buffer of the present application.

### DESCRIPTION OF EMBODIMENTS

In order to make the above-mentioned purposes, features and advantages of the present application more obvious and easy to understand, the present application is further described in detail below in conjunction with the accompanying drawings and specific implementations.

The scheme of the present application can be applied to optical communication scenarios.

Optical packet switching is a packet switching approach often used in optical communication scenarios. Data in optical communication scenarios are often embodied as optical packets. An optical packet includes an optical packet header and an optical packet payload, etc., and an optical switch can be used for optical packet switching. An optical packet header may include information of an optical packet such as a source address, a destination address, a lifetime and a lifespan of the optical packet.

Optical packet switching is usually performed by an optical switch. The optical switch does not need to perform optical-to-electrical or electrical-to-optical conversion on optical signals, but can directly switch the optical signals. The optical switch may include a Fast Optical Switch, etc. Due to dynamic sharing and statistical multiplexing of bandwidth resources, optical packet switching can improve the utilization rate of network bandwidth resources and make the network very flexible.

In optical communication scenarios, optical switches usually forward optical packets directly, which is prone to optical packet switching conflicts.

For example, an input port of an optical switch may receive optical packets sent by a device in a data center and transmit the optical packets to an output port. The output port can output the optical packets to a destination device in the data center. When multiple input ports of the optical switch transmit optical packets to the same output port at the same time, there may be a situation where some optical packets cannot reach the output port, causing optical packet switching conflicts. Although a retransmission mechanism can be used to retransmit optical packets when there is a conflict in optical packet switching (i.e., a controller of the optical switch sends flow control information to each device to inform each device that the transmission of the optical packet fails, so that the device retransmits the optical packet in a next time slot), the retransmission mechanism results in low throughput of the optical switch and thus low quality in switching optical packets.

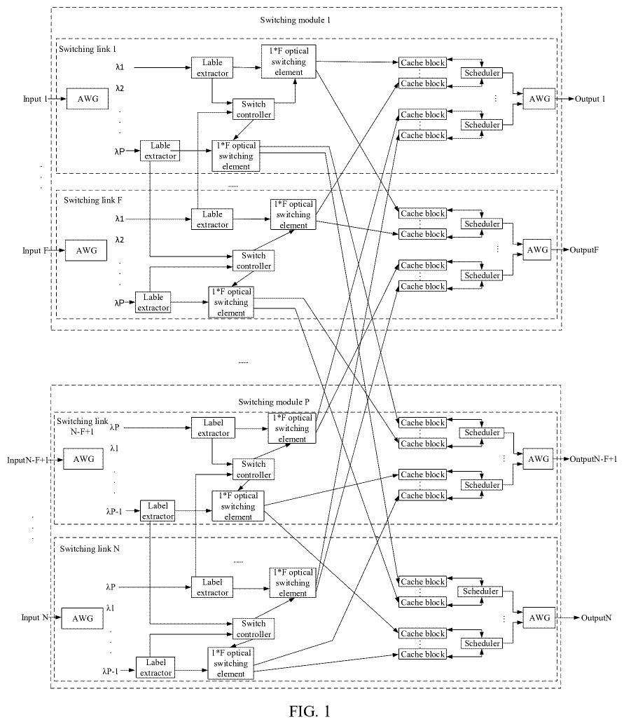

In order to improve the quality in switching optical packets, referring to FIG. 1, an optical switch of the present application is illustrated, which includes:
P switching modules, where P includes an amount of types of wavelengths of optical packets of which switching is supported by the optical switch; each switching module includes F switching links; both P and F are positive integers.

For example, the wavelengths of optical packets of which switching is supported by the optical switch include λ₁-λ_{P}. The wavelengths λ₁-λ_{P} include P wavelengths in total.

P switching modules may be parallel.

Switching links in a same switching module may be parallel.

For any switching link in any switching module, the switching link may include: a splitter, an aggregator, F cache groups, and schedulers respectively corresponding to the cache groups. A cache group includes multiple cache blocks.

The switching link has an output end and an input end.

The input end of the switching link includes an input end of the splitter in the switching link.

The output end of the switching link includes an output end of the aggregator in the switching link.

The aggregator may include: an Arrayed Waveguide Grating (AWG), etc.

The input end of the switching link is connected to a data center, and the output end of the switching link is connected to another data center.

The same applies to each switching link in each other switching module.

In this way, the optical switch can perform optical packet switching between two data centers.

The data center may include multiple devices, that is, the data center may be regarded as a network cluster, and the devices include: devices that can perform optical communication with the optical switch and can send and receive optical signals. For example, the devices may include: a Top of Rack Switch (ToR) or a server or a terminal, etc.

For any switching link in any switching module, the splitter in the switching link is configured to receive an input optical signal and separate the input optical signal into optical packets of various wavelengths.

For example, the input optical signal may include optical packets of multiple different wavelengths, and all these multiple different wavelengths are wavelengths of optical packets of which switching is supported by the optical switch.

For any wavelength, the splitter in the switching link is further configured to determine, from the P switching modules, a switching module for outputting optical packets of the wavelength, and store the optical packets of the wavelength in a cache group corresponding to the wavelength in one of the switching links of the determined switching module.

In the present application, for the P switching modules, different switching modules are used to output optical packets of different wavelengths.

For example, a switching module is used to output optical packets of F different wavelengths. Switching module 1 is used to output optical packets of wavelengths λ₁-λ_{F}, switching module 2 is used to output optical packets of wavelengths λ_{F+1}-λ_{2F}, switching module 3 is used to output optical packets of wavelengths λ2_{F+1}-λ_{3F} . . . and so on, switching module P is used to output optical packets of wavelengths λ_{N-F+1}-λ_{N}.

A scheduler corresponding to any cache group in the switching link is configured to schedule one of the optical packets of the wavelength in the cache group to the aggregator in the switching link.

The switching link supports outputting one optical packet of the wavelength in one time slot, but does not support simultaneously outputting two different optical packets of the wavelength in one time slot. Thus, the scheduler corresponding to any cache group in the switching link is configured to schedule one of the optical packets of the wavelength in the cache group to the aggregator in the switching link, so that the aggregator can output this one of the optical packets.

The aggregator in the switching link is configured to aggregate optical packets of the various wavelengths respectively scheduled by the schedulers in the switching link into an output optical signal, and output the optical signal.

In an embodiment of the present application, the splitter includes:

a separator, a switch controller, Label Extractors (LEs) respectively corresponding to the various wavelengths, and optical switching elements (OS, Optical Switch) respectively corresponding to the various wavelengths.

An optical switching element may include a 1*F optical switching element.

The separator includes an AWG, etc.

In an example, there are P label extractors, which respectively correspond to P different wavelengths (such as λ₁-λ_{P}, etc.) of optical packets of which switching is supported by the optical switch.

The input end of the splitter includes an input end of the separator, and the separator includes P output ends, and the P output ends are respectively connected to input ends of the label extractors respectively corresponding to different wavelengths (for example, respectively connected to the input ends of the label extractors respectively corresponding to P different wavelengths).

Output ends of the label extractors corresponding to different wavelengths are respectively connected to input ends of the optical switching elements respectively corresponding to the different wavelengths.

In addition, for the switching link in the switching module mentioned above, the splitter in the switching link includes a switch controller.

The switch controller includes N input ends and N output ends, where Nis equal to F*P.

The N input ends of the switch controller are respectively connected to output ends of label extractors corresponding to one of wavelengths in the F switching links (there are a total of F switching links) included in one of the P switching modules.

The one of wavelengths is one of multiple different wavelengths of the optical packets output by the switching module.

The N input ends of the switch controller in a different switching link in the switching module are connected to output ends of label extractors corresponding to a different wavelength in the F switching links (there are a total of F switching links) included in one of the P switching modules.

For the optical switching elements respectively corresponding to the various wavelengths in the splitter, any wavelength corresponds to an optical switching element in the optical switching elements.

The optical switching element has F output ends, and the F output ends are respectively connected with input ends of cache groups corresponding to the wavelength in the F switching links of the switching module for outputting the optical packets of the wavelength in the P switching modules.

The optical switching element can be a 1*F switching element, that is, with F output ends, of which F-1 output ends may be turned off, and 1 output end may be turned on, so that the optical packets of the wavelength can be transmitted to the input end of the cache group with which the turned-on output end is connected, the cache group corresponding to the wavelength and being in the switching link (there are a total of F switching links), so as to realize the storage of the optical packets of the wavelength in the cache group corresponding to the wavelength in the switching link, where the input end of the cache group is connected with the turned-on output end.

It may be specifically controlled by the switch controller as to which output end of the optical switching element is turned on and which output ends of the optical switching element are turned off.

For example, such control by the switch controller can be implemented according to at least the optical packet headers of the optical packets.

In each switching link in the present application, the separator in the splitter is configured to receive an input optical signal and separate the input optical signal into optical packets of various wavelengths.

The separator may include an AWG, and the AWG may include a 1×P AWG. The 1×P AWG is configured to separate the physical link into p wavelength channels, which are respectively recorded as wavelength channel λ₁, wavelength channel λ₂, . . . , and wavelength channel λ_{P}, so that the input optical signal can be separated into optical packets of p different wavelengths, for example, optical packets of wavelength λ₁, optical packets of wavelength λ₂, . . . , and optical packets of wavelength λ_{P}, etc.

The aggregator in the present application may include an AWG, and the AWG may include a 1×F AWG.

The 1×F AWG (aggregator) is configured to aggregate F wavelength channels into one physical link.

For example, the 1×F AWG (aggregator) in each switching link in switching module 1 is configured to aggregate the wavelength channels λ₁-λ_{F} into one physical link, the 1×F AWG (aggregator) in each switching link in switching module 2 is configured to aggregate the wavelength channels λ_{F+1}-λ_{2F} into another physical link, . . . , and the 1×F AWG (aggregator) in each switching link in switching module P is configured to aggregate the wavelength channels λ_{N-F+1}-λ_{N} into another physical link, etc.

In this way, the 1×F AWG (aggregator) in each switching link in switching module 1 is configured to aggregate the optical packets of λ₁ to λ^{F} into an output optical signal, and output the output optical signal obtained through aggregation, the 1×F AWG (aggregator) in each switching link in switching module 2 is configured to aggregate the optical packets of λ_{F+1}−λ_{2F} into an output optical signal, and output the output optical signal obtained through aggregation, . . . , and the 1×F AWG (aggregator) in each switching link in switching module P is configured to aggregate the optical packets of λ_{N-F+1}-λ_{N} into an output optical signal, and output the output optical signal obtained through aggregation, etc.

Through this application, the conflict of AWG on the output side can be avoided.

For example, for any switching link in any switching module, there are F schedulers in the switching link, corresponding to different wavelengths respectively, and the wavelengths of the optical packets scheduled by the F schedulers to the aggregator in the switching link are different. Thus, the wavelengths of the optical packets obtained by the aggregator in the switching link are different (there will not be a situation that among the optical packets obtained by the aggregator in the switching link, two or more optical packets have the same wavelength). For example, F different optical packets can be obtained, and it is possible to aggregate the F different optical packets into an output optical signal and output the output optical signal. Thus, the situation where two or more optical packets with the same wavelength conflict in the aggregator of the same switching link in the same time slot can be avoided.

In an embodiment of the present application, for any switching link in any switching module, after the separator in the switching link separates the input optical signal into optical packets of multiple wavelengths, for any wavelength, the separator in the switching link is configured to input the separated optical packets of the wavelength into a label extractor corresponding to the wavelength.

The label extractor corresponding to the wavelength is configured to extract the optical packet headers and the optical packet payloads from the optical packets of the wavelength, and transmit the optical packet headers to the switch controller, and transmit the optical packet payloads to an optical switching element corresponding to the wavelength.

The switch controller is configured to determine, from the P switching modules according to the optical packet headers, the switching module for outputting the optical packets of the wavelength and send a cache instruction to the optical switching element corresponding to the wavelength. The cache instruction is used to instruct to store the optical packets of the wavelength in a cache group corresponding to the wavelength in one of the switching links of the determined switching module.

The optical switching element corresponding to the wavelength is configured to store, according to the cache instruction, the optical packets of the wavelength in the cache group corresponding to the wavelength in the one of the switching links in the determined switching module.

In an embodiment of the present application, for any switching link in any switching module and for any wavelength, the cache group corresponding to the wavelength in the switching link includes multiple cache blocks, and different cache blocks correspond to different switching links in the switching links included in one of the P switching modules. That is, different cache blocks among the multiple cache blocks included in the cache group corresponding to the wavelength in the switching link are configured to store the optical packets of the wavelength obtained by different switching links in the F switching links included in one of the P switching modules.

In this way, the cache instruction can be used to instruct to store the optical packets of the wavelength in a cache block of the cache group corresponding to the wavelength in one of the switching links of the determined switching module, where the cache block corresponds to the one of the switching links of the determined switching module.

Correspondingly, the optical switching element corresponding to the wavelength is configured to store, according to the cache instruction, the optical packets of the wavelength in the cache block of the cache group corresponding to the wavelength in the one of the switching links of the determined switching module, where the cache block corresponds to the one of the switching links of the determined switching module.

In another embodiment of the present application, the cache block includes a delay feedback optical buffer.

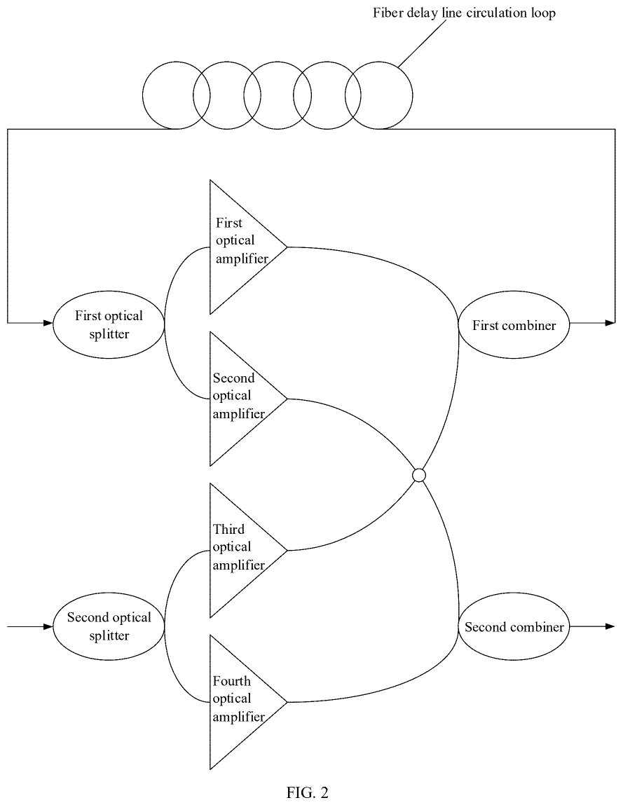

Referring to FIG. 2, the delay feedback optical buffer includes:
a first optical splitter, a first combiner, a second optical splitter, a second combiner, a controller, a first optical amplifier, a second optical amplifier, a third optical amplifier, a fourth optical amplifier, and a fiber delay line circulation loop.
an input end of the first optical splitter is connected with an output end of the fiber delay line circulation loop;
an output end of the first optical splitter is connected with an input end of the first optical amplifier and an input end of the second optical amplifier;
an output end of the first optical amplifier is connected with an input end of the first combiner;
an output end of the second optical amplifier is connected with an input end of the second combiner;
an output end of the first combiner is connected with an input end of the fiber delay line circulation loop;
the second optical splitter is configured to receive the optical packets of the wavelength;
an output end of the second optical splitter is connected with an input end of the third optical amplifier and an input end of the fourth optical amplifier;
an output end of the third optical amplifier is connected with the input end of the first combiner;
an output end of the fourth optical amplifier is connected with the input end of the second combiner;
an output end of the second combiner is connected to an output end of the scheduler;
the scheduler is configured to control turning on or off of the first optical amplifier, the second optical amplifier, the third optical amplifier and the fourth optical amplifier according to the controller (not shown).

In the delay feedback optical buffer shown in FIG. 2, an optical packet is input from the input end of the second optical splitter. If the controller controls the third optical amplifier to be turned off and the fourth optical amplifier to be turned on, the optical packet flows to the second combiner and is output to outside of the cache block through the second combiner, for example, to a scheduler through the second combiner.

If the controller controls the fourth optical amplifier to be turned off and the third optical amplifier to be turned on, the optical packet flows to the first combiner, is output to the fiber delay line circulation loop through the first combiner (to achieve caching of the optical packet in the delay feedback optical buffer), and then circulates to the input end of the first optical splitter in the cache block.

If the controller controls the first optical amplifier to be turned on and the second optical amplifier to be turned off, the optical packet also flows to the first combiner, is output to the fiber delay line circulation loop through the first combiner (to achieve continued caching of the optical packet in the delay feedback optical buffer), and then circulates to the input end of the first optical splitter in the cache block.

If the controller controls the second optical amplifier to be turned on and the first optical amplifier to be turned off, the optical packet flows to the second combiner and is output to the outside of the cache block through the second combiner (no longer caching the optical packet in the delay feedback optical buffer), for example, to the scheduler through the second combiner.

It should be noted that FIG. 2 is only an example of one form of delay feedback optical buffer in the present application, and other forms of delay feedback optical buffer may also be used, which is not limited in the present application.

In another embodiment of the present application, a storage space of the cache block is determined according to at least L_{d}, L and r.

L_{d} includes: the maximum number of bits of optical packets that can be carried simultaneously on a link between one input end of the optical switch and a device that sends the input optical signal. The unit of length may include the number of bits (such as Byte or bit, etc.).

L includes the number of bits of an optical packet.

r includes the rate at which the optical switch switches optical packets.

For example, the storage space of the cache block is less than or equal to (4+2*L_{d}/L−r)*L.

In the present application, the number of bits of each optical packet may be the same, for example, L.

The maximum number of bits of optical packets that can be carried simultaneously on the link can be understood as: the maximum number of bits of optical packets that can be transmitted simultaneously on the link.

For example, assuming that the link between an input end of the optical switch and a device that sends the input optical signal can carry 10 optical packets simultaneously, then La can be 10 L.

Or, assuming that the maximum number of bits that can be carried simultaneously on the link between an input end of the optical switch and a device that sends the input optical signal is 10 L (L_{d}), then the link between the input end of the optical switch and the device that sends the input optical signal can carry 10 optical packets simultaneously, for example, can transmit 10 optical packets simultaneously.

In another embodiment of the present application, the number of the delay feedback optical buffer is determined based on L_{d} and L.

L_{d} includes: the maximum number of bits of optical packets that can be carried simultaneously on a link between an input end of the optical switch and a device that sends the input optical signal. The unit of length can include the number of bits (such as Byte or bit, etc.).

L includes the number of bits of an optical packet.

For example, the number of the delay feedback optical buffer is less than or equal to 4+2*L_{d}/L.

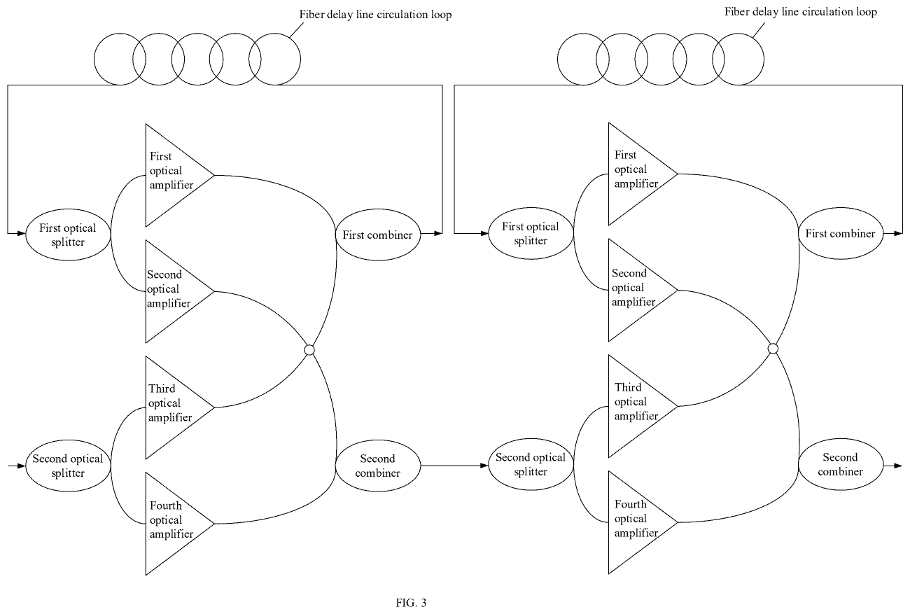

In an embodiment, when there are two or more delay feedback optical buffers, the two or more delay feedback optical buffers are connected in series. For example, referring to FIG. 3, the output end of the second combiner in the previous delay feedback optical buffer is connected with the input end of the second optical splitter in the next adjacent delay feedback optical buffer.

The goal of FFQ scheduling is to pursue the consistency of the service volume received in the optical packet flow with the service volume received in the ideal GPS scheduling.

In GPS scheduling, the service volume Wᵢⱼ obtained by the cached optical packet flow fᵢⱼ is not less than the ratio of the rate of the cached optical packet flow fᵢⱼ to the rate of the uncached optical packet flow, and there is the following relationship:

$$\frac{{W}_{{i}_{1} , {j}_{1}}}{{W}_{{i}_{2} , {j}_{2}}} \geq \frac{{r}_{{i}_{1} , {j}_{1}}}{{r}_{{i}_{2} , {j}_{2}}}$$

Then for an optical packet with a fixed number of bits, in actual packet scheduling, the time for FFQ to complete the service will not be later than the ideal GPS scheduling by one time slot, W_{FFQ}(0,t) and W_{GPS}(0,t) represent the scheduling volumes of FFQ scheduling and GPS scheduling respectively in the time period [0, t], then formula (1) can be obtained:

−L≤W_{FFQ}(0,t)−W_{GPS}(0,t)≤(1−r_{i,j})L (1)

Assume that an input port of switching link i of the optical switch is connected with device i in a data center.

The distance between each of devices i-N and the optical switch is d.

Let an optical packet flow from device i in one data center to device j in another data center be f_{i,j}, that is, an optical packet flow from input port i to output port j of the optical switch be f_{i,j}.

For device i, consider an optical packet with a fixed bit number of L.

Let

$${W}_{GPS}^{MB} ( 0 , t ) and {W}_{GPS}^{EB} ( 0 , t )$$

be the transmission amounts transmitted from MB GPS and EB respectively in time period (0, t) under GPS scheduling.

Let

$${W}_{F F Q}^{MB} ( 0 , t ) and {W}_{F F Q}^{B B} ( 0 , t )$$

be the transmission amounts transmitted from MB and EB respectively in time period (0, t) under FFQ scheduling.

MB (Micro-Buffer) is a cache block in a cache group in a switching link of the optical switch.

EB (Electric-Buffer) is an electric buffer in device i.

For the optical switch, in the time interval [0, t], assume that queue MB_{i,j} is empty at time instant s, MB_{i,j} is continuously not empty based on the ideal scheduling GPS in the time period [s, t]. If MB_{i,j} is empty at time instant t, let s=t.

Formula (2) can be obtained by FFQ packet scheduling simulating the characteristics of GPS fluid scheduling:

$${W}_{F F Q}^{B B} ( 0 , s ) \geq {W}_{G P S}^{B B} ( 0 , s ) - L \qquad ( 2 )$$

Since MB_{i,j} is empty before the time instant s and continues to be not empty under GPS scheduling after the time instant s, all optical packets arriving at the time instant s have been scheduled away, and a new optical packet arrives at the time instant s. Let L_{d} be the maximum number of bits of optical packets that can be carried simultaneously on the link between one input end of the optical switch and the device that sends the input optical signal, then formula (3) can be obtained:

$${W}_{G P S}^{MB} ( 0 , s ) \geq {W}_{F F Q}^{EB} ( 0 , s ) - L - {L}_{d} \qquad ( 3 )$$

With the FFQ scheduling characteristics, formulas (4) and (5) can be obtained:

$$- L \leq {W}_{F F Q}^{MB} ( 0 , s ) - {W}_{G P S}^{MB} ( 0 , s ) \leq ( 1 - {r}_{i , j} ) L \qquad ( 4 )$$

$$- L \leq {W}_{F F Q}^{B B} ( 0 , s ) - {W}_{G P S}^{E B} ( 0 , s ) \leq ( 1 - {r}_{i , j} ) L \qquad ( 5 )$$

Combining the above formulas, formula (6) can be obtained:

$${W}_{G P S}^{MB} ( 0 , s ) \geq {W}_{G P S}^{E B} ( 0 , s ) - 2 L - {L}_{d} \qquad ( 6 )$$

It is known that in the time period (s, t), the cache block continues to be not empty under GPS scheduling, so formula (7) can be obtained:

$${W}_{G P S}^{MB} ( s , t ) \geq {W}_{G P S}^{B B} ( s , t ) - {L}_{d} \qquad ( 7 )$$

Furthermore, formula (8) can be obtained:

$${W}_{G P S}^{MB} ( 0 , t ) \geq {W}_{G P S}^{E B} ( 0 , t ) - 2 L - 2 {L}_{d} \qquad ( 8 )$$

Combining formulas (4) and (5), formula (9) can be obtained:

$${W}_{F F Q}^{E B} ( 0 , t ) - {W}_{F F Q}^{MB} ( 0 , t ) \leq ( 4 + 2 {L}_{d} / L - {r}_{i , j} ) L \qquad ( 9 )$$

That is, the cache upper limit of MB_{i,j} can be (4+2*L_{d}/L−r)*L.

Through this application, the maximum cache of MB_{i,j} only needs to be (4+2*L_{d}/L−r)*L to meet the quality of switching optical packets as much as possible, without the need for a larger cache capacity, which can reduce hardware costs.

And the maximum number of the delay feedback optical buffer only needs to be 4+2*L_{d}/L to meet the quality of switching optical packets as much as possible, without the need for more delay feedback optical buffers, which can reduce hardware costs.

Each switching link of the optical switch in the present application has the cache group. For any switching link, if the wavelengths of at least two optical packets that need to be output through the switching link in a time slot are identical, other optical packets except one optical packet of the optical packets can be cached in the cache group in the switching link, and the one optical packet can be output in the time slot. The other optical packets cached in the cache group can be scheduled and output in a subsequent time slot, so as to avoid conflicts.

Secondly, the structure of the optical switch in the present application can support FFQ scheduling of optical packets, and the scheduler close to an output end in the switching link can be used for scheduling. In this way, scheduling can be implemented based on simple scheduling logic, the complexity can be reduced to 0 (logN), and the complexity of the entire optical switch can be simplified.

In addition, since the structure of the optical switch in the present application can support FFQ scheduling of optical packets, and FFQ scheduling can be an ideal scheduling based on GPS, broadband assurance can be achieved. For example, the throughput of the optical switch for switching optical packet can be improved, so as to improve the quality of the optical switch in switching the optical packets and obtain service quality assurance.

In addition, the present application also illustrates a data communication system, which includes:
at least one data center. The data center includes at least one terminal, an optoelectronic conversion device communicatively connected to the at least one terminal respectively, and the optical switch according to the above-mentioned embodiments, and the at least one terminal is communicatively connected with an input end of the optical switch through the optoelectronic conversion device.

The various embodiments in this specification are described in a progressive manner, and each embodiment focuses on the differences from other embodiments. Reference for the same and similar parts between the various embodiments can be made to each other.

The embodiments of the present application are described with reference to the flowcharts and/or block diagrams of the methods, terminal devices (systems), and computer program products according to the embodiments of the present application. It should be understood that each process and/or block in the flowchart and/or block diagram, and the combination of the processes and/or blocks in the flowchart and/or block diagram can be implemented by computer program instructions. These computer program instructions can be provided to a processor of a general-purpose computer, a special-purpose computer, an embedded processor, or other programmable information processing terminal device to generate a machine, so that the instructions executed by the processor of the computer or other programmable information processing terminal device generate an apparatus for implementing the functions specified in one or more processes in the flowchart and/or one or more blocks in the block diagram.

These computer program instructions may also be stored in a computer-readable memory that can guide a computer or other programmable information processing terminal device to work in a specific manner, so that the instructions stored in the computer-readable memory produce a product including an instruction apparatus, which implements the functions specified in one or more processes of the flowchart and/or one or more blocks of the block diagram.

These computer program instructions may also be loaded onto a computer or other programmable information processing terminal device, so that a series of operation steps are performed on the computer or other programmable terminal device to produce a computer-implemented process, so that the instructions executed on the computer or other programmable terminal device provide steps for implementing the functions specified in one or more processes of the flowchart and/or one or more blocks of the block diagram.

Although the preferred embodiments of the embodiments of the present application have been described, those skilled in the art may make additional changes and modifications to these embodiments once they know the basic creative concepts. Therefore, the attached claims are intended to be interpreted as including the preferred embodiments and all changes and modifications that fall within the scope of the embodiments of the present application.

Finally, it should also be noted that herein relational terms such as first and second, etc. are only used to distinguish one entity or operation from another entity or operation, and do not necessarily require or imply any such actual relationship or order between these entities or operations. Moreover, the terms “include”, “comprise” or any other variants thereof are intended to cover non-exclusive inclusion, so that a process, method, article or terminal device including a series of elements includes not only those elements, but also other elements not explicitly listed, or also includes elements inherent to such process, method, article or terminal device. In the absence of further restrictions, the elements defined by the sentence “includes one . . . ” do not exclude the existence of other identical elements in the process, method, article or terminal device including the elements.

The above is a detailed introduction to an optical switch and a data communication system provided by the present application. Specific examples are used herein to illustrate the principles and implementations of the present application. The description of the above embodiments is only used to help understand the method and its core idea of the present application; at the same time, for those skilled in the art, according to the idea of the present application, there will be changes in the specific implementations and application scope. In summary, the content of this specification should not be understood as a limitation on the present application.

1. An optical switch, wherein the optical switch comprises:
P switching modules, wherein P comprises an amount of types of wavelengths of optical packets of which switching is supported by the optical switch; each switching module comprises F switching links; both P and F are positive integers;
for each of the switching links, the switching link comprises: a splitter, an aggregator, F cache groups and schedulers respectively corresponding to the cache groups; each of the cache groups comprises multiple cache blocks;
the splitter in the switching link is configured to: receive an input optical signal, separate the input optical signal into optical packets of various wavelengths, and for any wavelength, determine, from the P switching modules, a switching module for outputting optical packets of the wavelength, and store the optical packets of the wavelength in a cache group corresponding to the wavelength in one of the switching links of the determined switching module;
a scheduler corresponding to any one of the cache groups in the switching link is configured to schedule one of the optical packets of the wavelength in the cache group to the aggregator in the switching link;
the aggregator in the switching link is configured to aggregate optical packets of the various wavelengths respectively scheduled by the schedulers in the switching link into an output optical signal, and output the output optical signal.

2. The optical switch according to claim 1, wherein the splitter comprises:
a separator, a switch controller, label extractors respectively corresponding to the various wavelengths, and optical switching elements respectively corresponding to the various wavelengths;
the separator is configured to: receive the input optical signal, separate the input optical signal into the optical packets of the various wavelengths, and for any wavelength, input the optical packets of the wavelength into a label extractor corresponding to the wavelength;
the label extractor corresponding to the wavelength is configured to: extract optical packet headers and optical packet payloads of the optical packets of the wavelength, transmit the optical packet headers to the switch controller, and transmit the optical packet payloads to an optical switching element corresponding to the wavelength;
the switch controller is configured to: determine, from the P switching modules according to the optical packet headers, the switching module for outputting the optical packets of the wavelength, and send a cache instruction to the optical switching element corresponding to the wavelength; wherein the cache instruction is used to instruct to store the optical packets of the wavelength in the cache group corresponding to the wavelength in one of the switching links of the determined switching module;
the optical switching element corresponding to the wavelength is configured to store, according to the cache instruction, the optical packets of the wavelength in the cache group corresponding to the wavelength in the one of the switching links of the determined switching module.

3. The optical switch according to claim 2, wherein the cache group corresponding to the wavelength comprises multiple cache blocks, and different cache blocks respectively correspond to different switching links among the switching links comprised in one of the P switching modules;
the cache instruction is used to instruct to store the optical packets of the wavelength in a cache block of the cache group corresponding to the wavelength in one of the switching links of the determined switching module, wherein the cache block corresponds to the one of the switching links of the determined switching module;
the optical switch corresponding to the wavelength is configured to store, according to the cache instruction, the optical packets of the wavelength in the cache block of the cache group corresponding to the wavelength in the one of the switching links of the determined switching module, wherein the cache block corresponds to the one of the switching links of the determined switching module.

4. The optical switch according to claim 3, wherein the cache block comprises a delay feedback optical buffer.

5. The optical switch according to claim 4, wherein the delay feedback optical buffer comprises:
a first optical splitter, a first combiner, a second optical splitter, a second combiner, a controller, a first optical amplifier, a second optical amplifier, a third optical amplifier, a fourth optical amplifier and a fiber delay line circulation loop;
an input end of the first optical splitter is connected with an output end of the fiber delay line circulation loop;
an output end of the first optical splitter is connected with an input end of the first optical amplifier and an input end of the second optical amplifier;
an output end of the first optical amplifier is connected with an input end of the first combiner;
an output end of the second optical amplifier is connected with an input end of the second combiner;
an output end of the first combiner is connected with an input end of the fiber delay line circulation loop;
the second optical splitter is configured to receive the optical packets of the wavelength;
an output end of the second optical splitter is connected with an input end of the third optical amplifier and an input end of the fourth optical amplifier;
an output end of the third optical amplifier is connected with the input end of the first combiner;
an output end of the fourth optical amplifier is connected with the input end of the second combiner;
an output end of the second combiner is connected to an output end of the scheduler;
the scheduler is configured to control turning on or off of the first optical amplifier, the second optical amplifier, the third optical amplifier and the fourth optical amplifier according to the controller.

6. The optical switch according to claim 4, wherein a storage space of the cache block is determined according to at least L_{d}, L and r;
L_{d} comprises: a maximum number of bits of optical packets that can be carried simultaneously on a link between one input end of the optical switch and a device that sends the input optical signal;
L comprises a number of bits of an optical packet;
r comprises a rate at which the optical switch switches optical packets.

7. The optical switch according to claim 6, wherein the storage space of the cache block is less than or equal to (4+2*L_{d}/L-r)*L.

8. The optical switch according to claim 4, wherein an amount of the delay feedback optical buffer is determined according to L_{d} and L;
L_{d} comprises: a maximum number of bits of optical packets that can be carried simultaneously on a link between one input end of the optical switch and a device that sends the input optical signal;
L comprises a number of bits of an optical packet.

9. The optical switch according to claim 8, wherein the amount of the delay feedback optical buffer is less than or equal to 4+2*L_{d}/L.

10. The optical switch according to claim 4, wherein in a case that there are two or more delay feedback optical buffers, the two or more delay feedback optical buffers are connected in series.

11. A data communication system, wherein the data communication system comprises:
at least one data center;
the data center comprises at least one terminal, an optoelectronic conversion device communicatively connected to the at least one terminal respectively, and an optical switch, wherein the at least one terminal is communicatively connected with an input end of the optical switch through the optoelectronic conversion device;
wherein the optical switch comprises:
P switching modules, wherein P comprises an amount of types of wavelengths of optical packets of which switching is supported by the optical switch; each switching module comprises F switching links; both P and F are positive integers;
for each of the switching links, the switching link comprises: a splitter, an aggregator, F cache groups and schedulers respectively corresponding to the cache groups; each of the cache groups comprises multiple cache blocks;
the splitter in the switching link is configured to: receive an input optical signal, separate the input optical signal into optical packets of various wavelengths, and for any wavelength, determine, from the P switching modules, a switching module for outputting optical packets of the wavelength, and store the optical packets of the wavelength in a cache group corresponding to the wavelength in one of the switching links of the determined switching module;
a scheduler corresponding to any one of the cache groups in the switching link is configured to schedule one of the optical packets of the wavelength in the cache group to the aggregator in the switching link;
the aggregator in the switching link is configured to aggregate optical packets of the various wavelengths respectively scheduled by the schedulers in the switching link into an output optical signal, and output the output optical signal.

12. The optical switch according to claim 11, wherein the splitter comprises:
a separator, a switch controller, label extractors respectively corresponding to the various wavelengths, and optical switching elements respectively corresponding to the various wavelengths;
the separator is configured to: receive the input optical signal, separate the input optical signal into the optical packets of the various wavelengths, and for any wavelength, input the optical packets of the wavelength into a label extractor corresponding to the wavelength;
the label extractor corresponding to the wavelength is configured to: extract optical packet headers and optical packet payloads of the optical packets of the wavelength, transmit the optical packet headers to the switch controller, and transmit the optical packet payloads to an optical switching element corresponding to the wavelength;
the switch controller is configured to: determine, from the P switching modules according to the optical packet headers, the switching module for outputting the optical packets of the wavelength, and send a cache instruction to the optical switching element corresponding to the wavelength; wherein the cache instruction is used to instruct to store the optical packets of the wavelength in the cache group corresponding to the wavelength in one of the switching links of the determined switching module;
the optical switching element corresponding to the wavelength is configured to store, according to the cache instruction, the optical packets of the wavelength in the cache group corresponding to the wavelength in the one of the switching links of the determined switching module.

13. The optical switch according to claim 12, wherein the cache group corresponding to the wavelength comprises multiple cache blocks, and different cache blocks respectively correspond to different switching links among the switching links comprised in one of the P switching modules;
the cache instruction is used to instruct to store the optical packets of the wavelength in a cache block of the cache group corresponding to the wavelength in one of the switching links of the determined switching module, wherein the cache block corresponds to the one of the switching links of the determined switching module;
the optical switch corresponding to the wavelength is configured to store, according to the cache instruction, the optical packets of the wavelength in the cache block of the cache group corresponding to the wavelength in the one of the switching links of the determined switching module, wherein the cache block corresponds to the one of the switching links of the determined switching module.

14. The optical switch according to claim 13, wherein the cache block comprises a delay feedback optical buffer.

15. The optical switch according to claim 14, wherein the delay feedback optical buffer comprises:
a first optical splitter, a first combiner, a second optical splitter, a second combiner, a controller, a first optical amplifier, a second optical amplifier, a third optical amplifier, a fourth optical amplifier and a fiber delay line circulation loop;
an input end of the first optical splitter is connected with an output end of the fiber delay line circulation loop;
an output end of the first optical splitter is connected with an input end of the first optical amplifier and an input end of the second optical amplifier;
an output end of the first optical amplifier is connected with an input end of the first combiner;
an output end of the second optical amplifier is connected with an input end of the second combiner;
an output end of the first combiner is connected with an input end of the fiber delay line circulation loop;
the second optical splitter is configured to receive the optical packets of the wavelength;
an output end of the second optical splitter is connected with an input end of the third optical amplifier and an input end of the fourth optical amplifier;
an output end of the third optical amplifier is connected with the input end of the first combiner;
an output end of the fourth optical amplifier is connected with the input end of the second combiner;
an output end of the second combiner is connected to an output end of the scheduler;
the scheduler is configured to control turning on or off of the first optical amplifier, the second optical amplifier, the third optical amplifier and the fourth optical amplifier according to the controller.

16. The optical switch according to claim 14, wherein a storage space of the cache block is determined according to at least L_{d}, L and r;
L_{d} comprises: a maximum number of bits of optical packets that can be carried simultaneously on a link between one input end of the optical switch and a device that sends the input optical signal;
L comprises a number of bits of an optical packet;
r comprises a rate at which the optical switch switches optical packets.

17. The optical switch according to claim 16, wherein the storage space of the cache block is less than or equal to (4+2*L_{d}/L-r)*L.

18. The optical switch according to claim 14, wherein an amount of the delay feedback optical buffer is determined according to L_{d} and L;
L_{d} comprises: a maximum number of bits of optical packets that can be carried simultaneously on a link between one input end of the optical switch and a device that sends the input optical signal;
L comprises a number of bits of an optical packet.

19. The optical switch according to claim 18, wherein the amount of the delay feedback optical buffer is less than or equal to 4+2*L_{d}/L.

20. The optical switch according to claim 14, wherein in a case that there are two or more delay feedback optical buffers, the two or more delay feedback optical buffers are connected in series.
